(19) United States
(12) Patent Application Publication
(10) Pub. No.: US 2018/0084178 A1
(43) Pub. Date: Mar. 22, 2018

(54) SMART CAMERA FLASH SYSTEM

(71) Applicant: QUALCOMM Incorporated, San Diego, CA (US)

(72) Inventors: Jitendra Singh TOMAR, Hyderabad (IN); Udit BANSAL, Hyderabad (IN)

(21) Appl. No.: 15/267,389

(22) Filed: Sep. 16, 2016

(51) Int. Cl. H04N 5/235; H04N 5/225

(52) U.S. Cl. CPC H04N 5/2354; H04N 5/2256; H04N 5/2351

(57) ABSTRACT

In an aspect of the disclosure, a method, a computer-readable medium, and an apparatus are provided. The apparatus may be a user equipment (UE) that includes a camera and a plurality of flash lights. The apparatus may detecting a real time light level of a scene. The apparatus may determine a flash light setting for the plurality of flash lights based on the detected real time light level. The flash light setting may include the operating voltage level for each of the plurality of flash lights and the number of the plurality of flash lights to be turned on. The apparatus may configure the plurality of flash lights based on the flash light setting.

### FIELD

The present disclosure relates generally to cameras, and more particularly, to camera flash systems.

### BACKGROUND

A smart phone may be equipped with a camera and a camera flash component. When under low ambient light, the camera flash component may emit a flash of artificially generated light during photo or video capture. The flash light emitted from the camera flash component may increase overall scene illumination to allow for brighter and/or higher quality photos or videos being captured.

With the advent of sophisticated camera sensors, flash light(s) and connected camera technologies in smart phones, battery drain problems may be common while using a camera system with flash light. The average current draw from battery may be even higher for a camera with multiple flash lights. Therefore, a multi flash system may have more adverse impact on battery operating time, and the battery may drain rapidly.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. The summary's purpose is to present some concepts of one or more aspects in a simplified form as a prelude to the more detailed description that is presented later.

With the advent of sophisticated camera sensors, multiple flash lights and connected camera technologies in smart phones, battery drain problems may be common while using a camera system with flash lights. Use of multiple flash lights to improve the quality of the photos and/or videos, while minimize the power consumption due to using the flash lights may be desirable.

In an aspect of the disclosure, a method, a computer-readable medium, and an apparatus are provided. The apparatus may be a user equipment (UE) that includes a camera and a plurality of flash lights. The apparatus may detect a real time light level of a scene. The apparatus may determine a flash light setting for the plurality of flash lights based on the detected real time light level. The flash light setting may include the operating voltage level for each of the plurality of flash lights and the number of the plurality of flash lights to be turned on. In one configuration, the flash light setting may include a setting for each flash light of the plurality of flash lights. The setting may include operating voltage/current, and/or on/off status of the flash light.

The apparatus may configure the plurality of flash lights based on the flash light setting. The apparatus may capture a video or snapshot of the scene with the configured plurality of flash lights. The detecting the real time light level, the determining the flash light setting, and the configuring the plurality of flash light may be performed periodically during a video capture session.

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 is a diagram illustrating an example of a smart phone with dual flash lights.

FIG. 2 is a diagram illustrating an example of a smart camera flash system.

FIG. 3 is a block diagram illustrating an example of using a light sensor to measure the ambient light condition of the surrounding area to dynamically adjust a flash light setting of an apparatus.

FIG. 4 is a block diagram illustrating an example of using machine learning algorithms to measure the ambient light condition to dynamically adjust a flash light setting of an apparatus.

FIG. 5 illustrates an example of a lookup table that may be used to determine a flash light setting for a UE.

FIG. 6 illustrates an example of a table for intelligently determining which flash light(s) to turn on.

FIG. 7 is a flowchart of a method of operating a camera.

FIG. 8 is a conceptual data flow diagram illustrating the data flow between different means/components in an exemplary apparatus.

FIG. 9 is a diagram illustrating an example of a hardware implementation for an apparatus employing a processing system.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of camera flash system will now be presented with reference to various apparatus and methods. These apparatus and methods will be described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software components, applications, software applications, software packages, routines, subroutines, objects, executables, threads of execution, procedures, functions, etc., whether referred to as software, firmware, middleware, microcode, hardware description language, or otherwise.

Accordingly, in one or more example embodiments, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise a random-access memory (RAM), a read-only memory (ROM), an electrically erasable programmable ROM (EEPROM), optical disk storage, magnetic disk storage, other magnetic storage devices, combinations of the aforementioned types of computer-readable media, or any other medium that can be used to store computer executable code in the form of instructions or data structures that can be accessed by a computer.

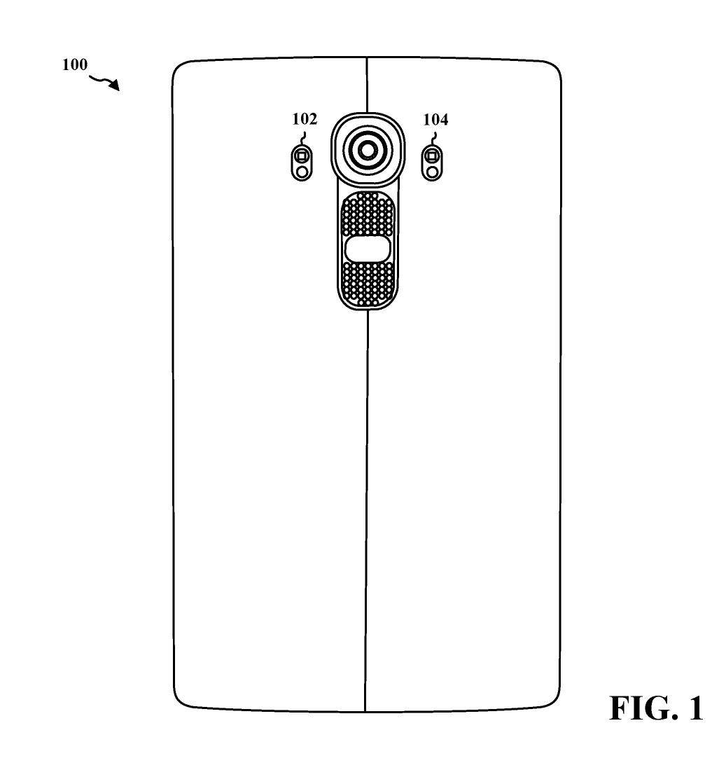

FIG. 1 is a diagram illustrating an example of a smart phone 100 with dual flash lights 102 and 104. The smart phone 100 may be referred to as a multi flash smart phone. In one configuration, the smart phone 100 may be used to capture a video for a certain period of time, e.g., 10 minutes. An auto flash solution may turn on or off the flash lights 102 and 104 before starting the video recording. Once the video recording is started, the configuration (e.g., on or off) of the flash lights 102 and 104 may not be changed. If the flash lights 102 and 104 are turned off before starting the video recording and the light condition deteriorates, the quality of the video may suffer, which may reduce user satisfaction with the video.

Alternatively, if the flash lights 102 and 104 are turned on before starting the video recording, operating the flash lights 102 and 104 for 10 minutes may draw approximately 5000 mA (e.g., 500 mA per minute times 10 minutes) from the battery. The increased current drawn from the battery may discharge the battery faster and may cause the phone to heat up due to the increased load caused by the flash lights 102 and 104.

In one configuration, the smart phone 100 may check ambient light conditions before starting video capture and may make the decision of flash lights on or off before starting the video capture. In such a configuration, the smart phone 100 may lack the intelligence of switching the flash lights on again if light conditions degrade during the video recording. There may be no intelligent selection of proper flash lights in a multi flash system. The smart phone 100 may switch on/off all flash lights (e.g., 102 and 104) and each flash light may use full voltage/current supply and provide maximum current drawn by the flash light when turned on.

For a snapshot use case, especially in multi flash smart phones, no intelligent system may be in place and the auto flash system may make the decision of flash lights on/off prior to taking the snapshot. The auto flash system may run all the available flash lights (e.g., 102 and 104) with full current/voltage and cause maximum current drawn by flashlights, which may result in a faster battery drain and bad thermal conditions for the smart phone (e.g., phone surface becoming hot to the touch). That is, the multi flash smart phone (e.g., the smart phone 100), may not intelligently choose the right combination of flash lights with optimal voltage or current supply, so that the photo or video captured by the phone may have satisfactory quality while reducing the battery drain by the flash lights.

The flash light solution described above with reference to FIG. 1 turns on camera flash lights without intelligent on/off selection of flash lights, and operates the flash lights with maximum possible supply voltage or current, which may draw maximum current from battery and cause bad thermal conditions for the phone. It may be desirable to achieve the same performance in terms of photo/video quality with an intelligent way of choosing the right flash light combinations with corresponding operating voltage and current to minimize battery draw.

Examples of a device with multi flash system may include a cellular phone, a smart phone, a laptop, a personal digital assistant (PDA), a game console, a tablet, a smart device, a wearable device, or any other similar functioning device. A device with multi flash system may also be referred to as a user equipment (UE), a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

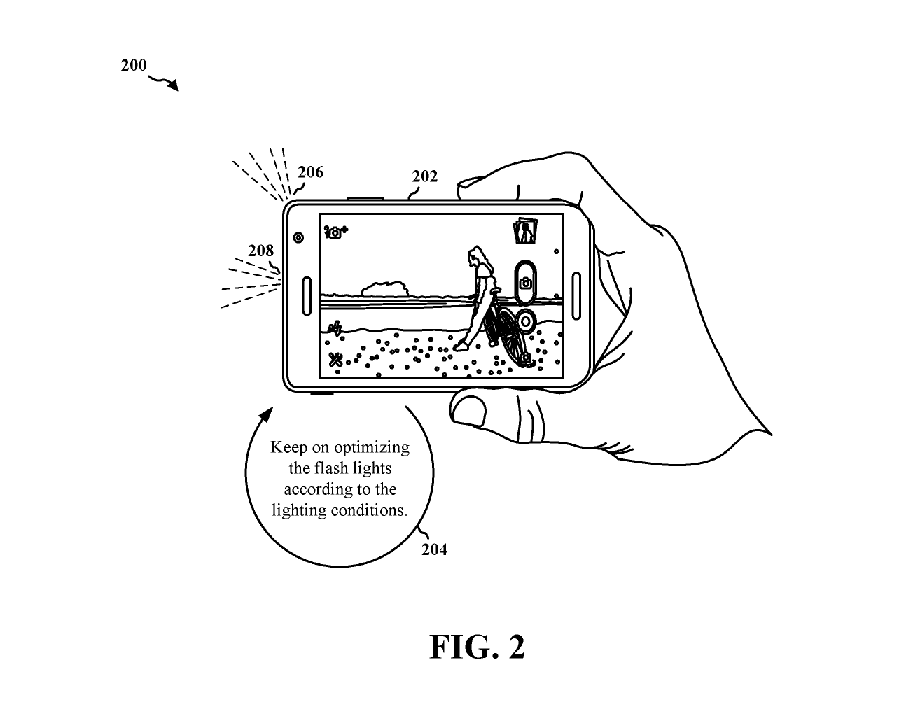

FIG. 2 is a diagram illustrating an example of a smart camera flash system 200. In this example, a UE 202 may include a camera and multiple flash lights (e.g., flash lights 206 and 208). The UE 202 may be used to record a video. During the recording of the video, the UE 202 may keep (at 204) on optimizing the flash lights (e.g., adjusting the number of flash lights turned on/off and/or the variable light output of each flash light turned on) according to the ambient/scene light conditions. As a result, the video may be captured with improved quality while improving battery operating time of the UE 202.

In one configuration, the smart camera flash system 200 may make real time decision regarding turning on or off camera flash lights 206 and/or 208, as well as the number of flash lights turned on according to the current ambient light conditions.

In one configuration, a light sensor of the UE 202 may continuously detect the ambient light in the surrounding environment. Based on the light conditions detected by the light sensor, the UE 202 may update flash light setting decisions with regard to the number of flash lights and which flash lights to turn on or off. The smart camera flash system 200 may calculate the best possible (e.g., maximum and/or highest quality light output with least power consumption) combination of flash lights 206 and 208 to provide light output for satisfactory video/photo capture. The smart camera flash system 200 may also decide the optimal operating current or voltage requirement for each flash light.

In one configuration, instead of or in conjunction with using the light sensor to detect the light conditions, the smart camera flash system 200 may use machine learning algorithms to compute light conditions based on images captured by the camera, and provide the recommendation of how much more/less light may be needed for proper exposure of the video/photo.

The smart camera flash system 200 may work with real time conditions. Thus, if light conditions change after a video capture session is started, the smart camera flash system 200 may adjust flash lights operating currents or voltages, and/or the number of flash lights turned on/off to provide improved performance with improved battery performance and thermal conditions. In one configuration, the smart camera flash system 200 may detect light condition changes and adjust flash lights periodically, e.g., every 1 second.

In one configuration, for taking snapshots, the smart camera flash system 200 may decide how many flash lights to turn on/off. The smart camera flash system 200 may also decide the voltage/current for each flash light to be turned on, in order to produce the desired light output based on the ambient light reading or exposure.

The smart camera flash system 200 may provide battery power savings when using a camera with multiple flash lights. The smart camera flash system 200 may result in better video encode quality. The smart camera flash system 200 may also produce a better camera snapshot with smart management of flash lights. The smart camera flash system 200 may improve user experience as the flash light settings may not need to be manually changed frequently. The smart camera flash system 200 may also improve thermal management of the phone while using camera systems with flash lights.

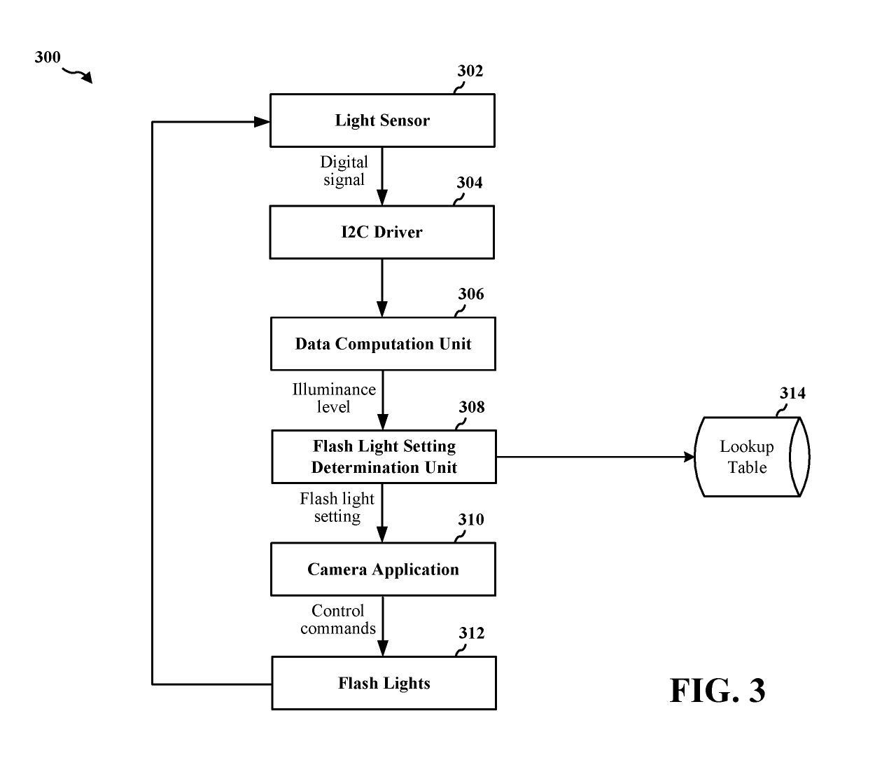

FIG. 3 is a block diagram illustrating an example of using a light sensor to measure the ambient light condition of the surrounding area to dynamically adjust flash light setting of an apparatus 300. In one configuration, the apparatus 300 may be a multi flash smart phone (e.g., the UE 202). In this example, the apparatus 300 may include a light sensor 302, an inter-integrated circuit (I2C) driver 304, a data computation unit 306, a flash light setting determination unit 308, a camera application 310, and a plurality of flash lights 312.

The light sensor 302 may be a high sensitivity light to digital converter that transforms light intensity into a digital signal output that may be passed through an I2C interface. The I2C driver 304 may be used to attach lower-speed peripheral integrated circuits (ICs), such as the light sensor 302, to processors and microcontrollers for short-distance communication. The I2C driver 304 may forward the digital signal received from the light sensor 302 to the data computation unit 306.

The data computation unit 306 may derive illuminance (e.g., ambient light) level in lux from the digital signal. The flash light setting determination unit 308 may decide in real time (e.g., continuously or periodically) to turn on or off the flash lights 312 based on the illuminance level received from the data computation unit 306. The flash light setting determination unit 308 may decide in real time (e.g., continuously or periodically) the number of flash lights to be turn on according to momentary ambient light conditions (e.g., illuminance level received from the data computation unit 306).

In one configuration, the flash light setting determination unit 308 may use values from a lookup table 314 to determine the flash light setting. The lookup table 314 may include a mapping between lux values and flash lights settings. Each flash light setting may include one or more of the number of flash lights to turn on/off, which of the flash lights 312 to be turned on (e.g., specified by the positions or identities of the flash lights to be turned on), or the voltage/current levels of each flash light to be turned on. In one configuration, instead of or in conjunction with using the lookup table 314, the flash light setting determination unit 308 may use a set of rules to determine the flash light setting. In one configuration, the flash lights to be turned on/off may be based on ambient light in a portion of the surrounding environment. In one configuration, the flash light setting may be adjusted based on whether camera lens is zoomed in or in wide angle mode.

The camera application 310 may configure the flash lights 312 based on the flash light setting received from the flash light setting determination unit 308 by sending control commands to the flash lights 312. The control commands may include turning on or off one or more of the flash lights 312, or the voltage/current level of each flash light to be turned on. In one configuration, the operations described above with reference to FIG. 3 may repeat periodically during the recording of a video.

The apparatus 300 may include additional components. The components may be one or more hardware components specifically configured to carry out the stated processes/algorithm, implemented by a processor configured to perform the stated processes/algorithm, stored within a computer-readable medium for implementation by a processor, or some combination thereof

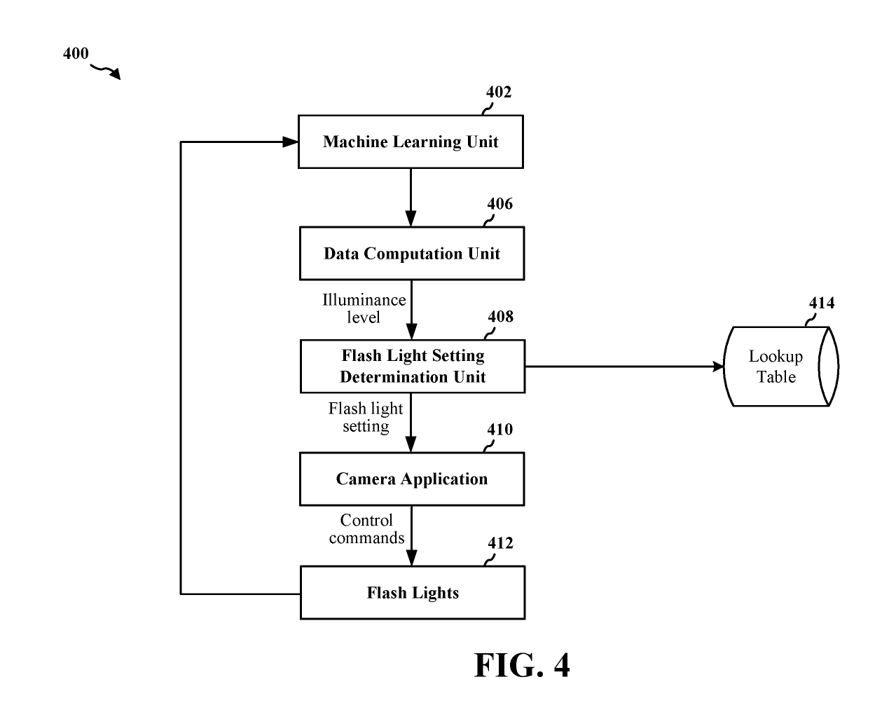

FIG. 4 is a block diagram illustrating an example of using machine learning algorithms to measure the ambient light condition to dynamically adjust flash light setting of an apparatus 400. In one configuration, the apparatus 400 may be a multi flash smart phone (e.g., the UE 202). In this example, the apparatus 400 may include a machine learning unit 402, a data computation unit 406, a flash light setting determination unit 408, a camera application 410, and a plurality of flash lights 412.

Machine learning is a subfield of computer science that evolved from the study of pattern recognition and computational learning theory in artificial intelligence. The machine learning unit 402 may use machine learning algorithms to compute the ambient light level of the scene.

The data computation unit 406 may derive illuminance (e.g., ambient light) level in lux from the signal received from the machine learning unit 402. The flash light setting determination unit 408 may decide in real time to turn on or off the flash lights 412 based on the illuminance level received from the data computation unit 406. The flash light setting determination unit 408 may decide in real time the number of flash lights to be turn on according to momentary ambient light conditions (e.g., illuminance level received from the data computation unit 406).

In one configuration, the flash light setting determination unit 408 may use values from a lookup table 414 to determine the flash light setting. The lookup table 414 may include a mapping between lux values and flash lights settings. Each flash light setting may include one or more of the number of flash lights to turn on/off, which of the flash lights 412 to be turned on (e.g., specified by the positions or identities of the flash lights to be turned on), or the voltage/current levels of each flash light to be turned on. In one configuration, instead of or in conjunction with using the lookup table 414, the flash light setting determination unit 408 may use a set of rules to determine the flash light setting.

The camera application 410 may configure the flash lights 412 based on the flash light setting received from the flash light setting determination unit 408 by sending control commands to the flash lights 412. The control commands may include turning on or off one or more of the flash lights 412, or the voltage/current level of each flash light to be turned on. In one configuration, the operations described above with reference to FIG. 4 may repeat periodically during the recording of a video.

The apparatus 400 may include additional components. The components may be one or more hardware components specifically configured to carry out the stated processes/algorithm, implemented by a processor configured to perform the stated processes/algorithm, stored within a computer-readable medium for implementation by a processor, or some combination thereof.

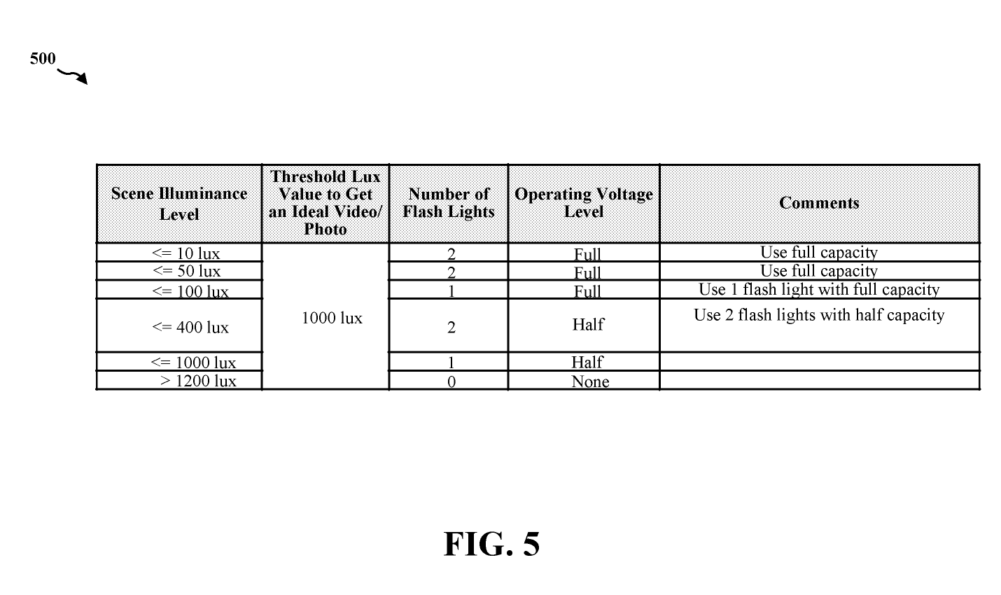

FIG. 5 illustrates an example of a lookup table 500 that may be used to determine a flash light setting for a UE. In one configuration, the lookup table 500 may be the lookup table 314 or 414 described above with reference to FIG. 3 or 4, respectively. In one configuration, the UE may be the UE 202, the apparatus 300 or 400. In this example, a multi flash smart phone may include two flash lights. One flash light may produce 500 lux light output and the threshold light output that may be needed to get a clear picture or video may be 1000 lux.

As illustrated in the lookup table 500, when the scene illuminance level is less than or equal to 10 lux, the UE may determine to turn on two flash lights, each of which uses full capacity (e.g., using maximum supply voltage/current to produce maximum light output). When the scene illuminance level is less than or equal to 50 lux but greater than 10 lux, the UE may determine to turn on two flash lights, each of which uses full capacity (e.g., using maximum supply voltage/current). When the scene illuminance level is less than or equal to 100 lux but greater than 50 lux, the UE may determine to turn on one flash light with full capacity (e.g., using maximum supply voltage/current).

When the scene illuminance level is less than or equal to 400 lux but greater than 100 lux, the UE may determine to turn on two flash lights, each of which uses half capacity (e.g., using half of the maximum supply voltage/current). In one configuration, using two flash lights with half capacity may provide the light output equal to using one flash light with full capacity. However, using two flash lights with half capacity may provide more light spread, thus the captured photo/vide may have higher quality.

When the scene illuminance level is less than or equal to 1000 lux but greater than 400 lux, the UE may determine to turn on one flash light with full capacity (e.g., using half of the maximum supply voltage/current). When the scene illuminance level is greater than 1200 lux, the UE may determine to turn off all flash lights. Similar lookup table may be specified for a camera flash system with more than two flash lights. In one configuration, the voltage/current level used by the flash lights may be controlled by the power management integrated circuit (PMIC).

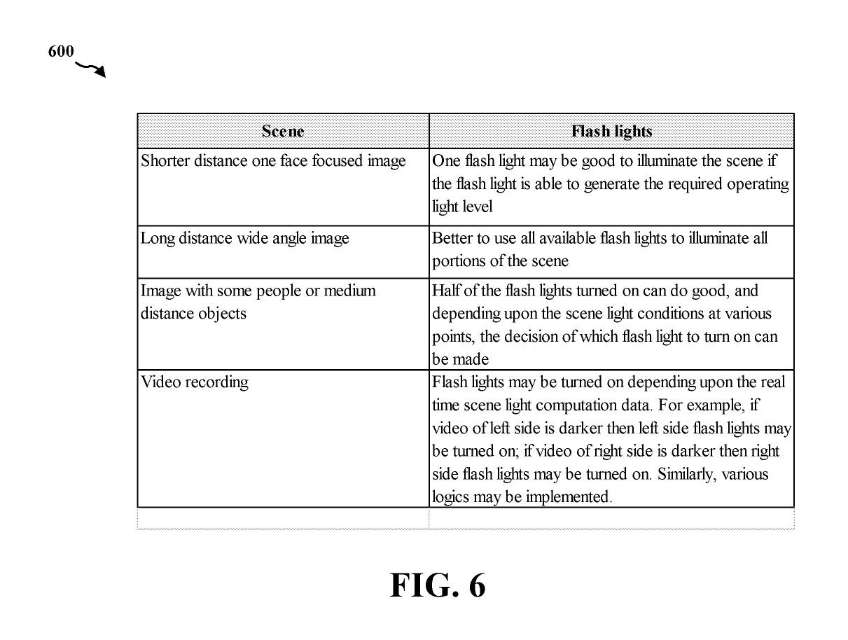

FIG. 6 illustrates an example of a table 600 for intelligently determining which flash light(s) to turn on. In one configuration, the table 600 may be used in combination with the lookup table 500 described above with reference to FIG. 5 to determine a flash light setting for a UE. As illustrated in the table 600, when the scene is a shorter distance one face focused image, the UE may determine to turn on one flash light if the flash light is able to generate the required operating light level. When the scene is a long distance wide angle image, the UE may determine to tum on all available flash lights to illuminate all portions of the scene. When the scene is an image with some people or medium distance objects, the UE may turn on half of the flash lights, and depending on the scene light conditions at various points, the decision of which flash light to turn on can be made. When the scene is a video recording, the UE may turn on flash lights depending on the real time scene light computation data. For example, if video of left side is darker, then left side flash light(s) may be turned on; if video of right side is darker, then right side flash light(s) may be turned on. Similarly, various logics may be implemented to turn on flash lights based on the real time scene light computation data.

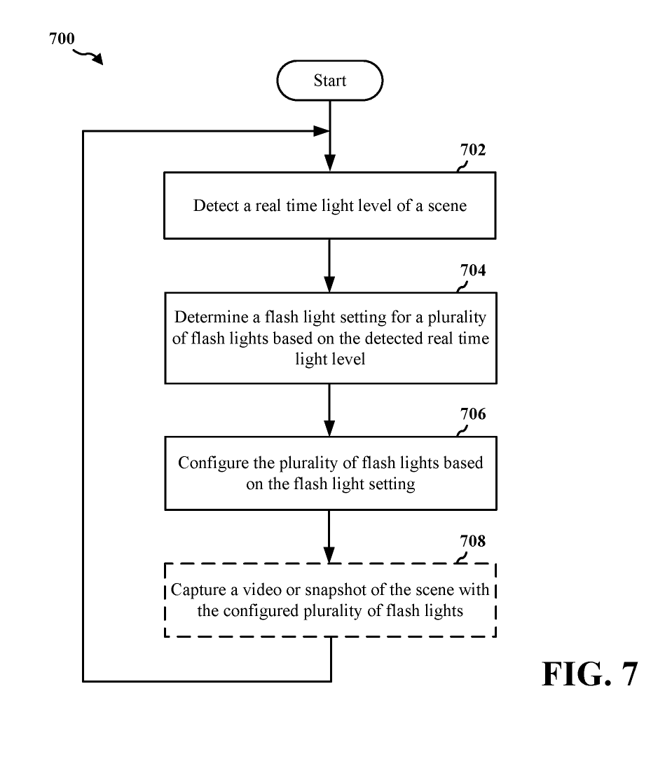

FIG. 7 is a flowchart 700 of a method of operating a camera. The method may be performed by a UE (e.g., the UE 202, the apparatus 300, 400, or 802/802′). The UE may include a camera and a plurality of flash lights. At 702, the UE may detect a real time light level of a scene. In one configuration, the real time light level of the scene may be detected with a light sensor (e.g., the light sensor 302). In one configuration, the real time light level of the scene may be detected by analyzing the scene with a machine learning algorithm (e.g., by using the machine learning unit 402).

At 704, the UE may determine a flash light setting for the plurality of flash lights based on the detected real time light level. In one configuration, the flash light setting may include the operating voltage or current level for each of the plurality of flash lights and the number of the plurality of flash lights to be turned on. The voltage or current level for the flash lights to be turned off may be zero. In one configuration, the position of each of the plurality of flash lights may determine whether the flash light will be turned on. In one configuration, the flash light setting may include the operating voltage or current level for one or more of a set of flash lights to be turned on, the number of the set of flash lights to be turned on, and a subset of the plurality of flash lights corresponding to the set of flash lights to be turned on. In one configuration, the subset of flash lights may be identified by positions or identities of the set of flash lights to be turned on. In one configuration, the flash light setting may include a setting for each flash light of the plurality of flash lights. The setting may include operating voltage/current, and/or on/off status of the flash light. In one configuration, operations performed at 704 may be performed by the flash light setting determination unit 308 or 408.

In one configuration, the operating voltage/current level may be less than the maximum supply voltage/current. In one configuration, the flash light setting may be determined based on a set of rules. For example, all flash lights may be turned on if the detected real time light level is less than a first threshold, and/or no flash light may be turned on if the detected real time light level is greater than a second threshold. In one configuration, the flash light setting may be determined based on a look-up table.

At 706, the UE may configure the plurality of flash lights based on the flash light setting. In one configuration, operations performed at 706 may be performed by the camera application 310 or 410.

At 708, the UE may optionally capture a video or snapshot of the scene with the configured plurality of flash lights. The UE may loop back to 702 to repeat the method.

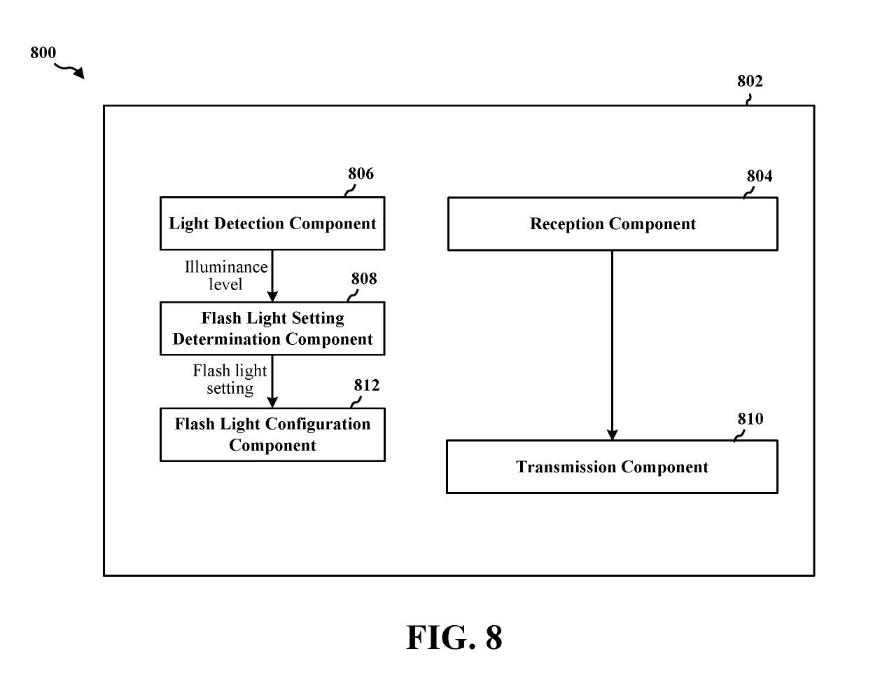

FIG. 8 is a conceptual data flow diagram 800 illustrating the data flow between different means/components in an exemplary apparatus 802. The apparatus 802 may be a UE. The apparatus 802 may include a reception component 804 that receives signals or messages from other devices. The apparatus 802 may include a transmission component 810 that sends signals or messages to other devices. The reception component 804 and the transmission component 810 may cooperate to coordinate the communication of the apparatus 802.

The apparatus 802 may include a light detection component 806 that detect ambient scene light level. In one configuration, the light detection component 806 may perform operations described above with reference to 702 in FIG. 7. In one configuration, the light detection component 806 may be the light sensor 302 or the machine learning unit 402.

The apparatus 802 may include a flash light setting determination component 808 that determines a flash light setting based on the illuminance level received from the light detection component 806. In one configuration, the flash light setting determination component 808 may perform operations described above with reference to 704 in FIG. 7. In one configuration, the flash light setting determination component 808 may be the flash light setting determination unit 308 or 408.

The apparatus 802 may include a flash light configuration component 812 that configures flash lights based on the flash light setting received from the flash light setting determination component 808. In one configuration, the flash light configuration component 812 may perform operations described above with reference to 706 in FIG. 7. In one configuration, the flash light configuration component 812 may be the camera application 310 or 410.

The apparatus may include additional components that perform each of the blocks of the algorithm in the aforementioned flowchart of FIG. 7. As such, each block in the aforementioned flowcharts of FIG. 7 may be performed by a component and the apparatus may include one or more of those components. The components may be one or more hardware components specifically configured to carry out the stated processes/algorithm, implemented by a processor configured to perform the stated processes/algorithm, stored within a computer-readable medium for implementation by a processor, or some combination thereof.

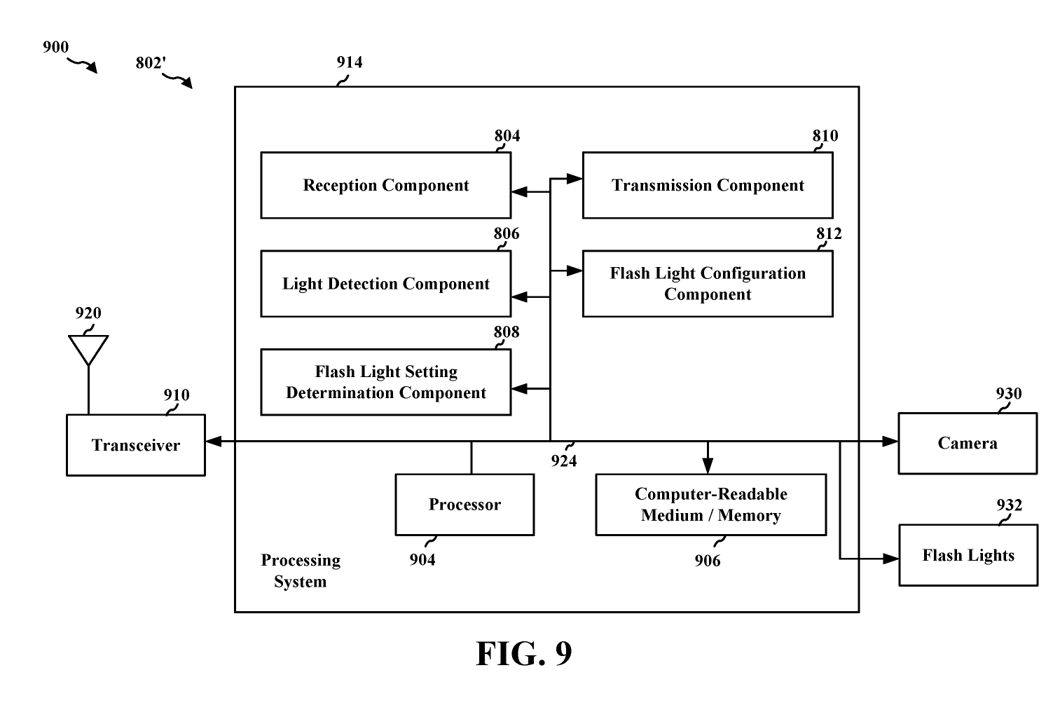

FIG. 9 is a diagram 900 illustrating an example of a hardware implementation for an apparatus 802′ employing a processing system 914. The processing system 914 may be implemented with a bus architecture, represented generally by the bus 924. The bus 924 may include any number of interconnecting buses and bridges depending on the specific application of the processing system 914 and the overall design constraints. The bus 924 links together various circuits including one or more processors and/or hardware components, represented by the processor 904, the components 804, 806, 808, 810, 812, and the computer-readable medium/memory 906. The bus 924 may also link various other circuits such as timing sources, peripherals, voltage regulators, and power management circuits, which are well known in the art, and therefore, will not be described any further.

The processing system 914 may be coupled to a transceiver 910. The transceiver 910 is coupled to one or more antennas 920. The transceiver 910 provides a means for communicating with various other apparatus over a transmission medium. The transceiver 910 receives a signal from the one or more antennas 920, extracts information from the received signal, and provides the extracted information to the processing system 914, specifically the reception component 804. In addition, the transceiver 910 receives information from the processing system 914, specifically the transmission component 810, and based on the received information, generates a signal to be applied to the one or more antennas 920.

The processing system 914 may be coupled to a camera 930. The camera 930 provides a means for capturing photos and/or videos, which may be stored into the processing system 914. The processing system 914 may be coupled to a plurality of flash lights 932. The plurality of flash lights provides a means for emitting artificially generated light during photo or video capture process of the camera 930.

The processing system 914 includes a processor 904 coupled to a computer-readable medium/memory 906. The processor 904 is responsible for general processing, including the execution of software stored on the computer-readable medium/memory 906. The software, when executed by the processor 904, causes the processing system 914 to perform the various functions described supra for any particular apparatus. The computer-readable medium/memory 906 may also be used for storing data that is manipulated by the processor 904 when executing software. The processing system 914 further includes at least one of the components 804, 806, 808, 810, 812. The components may be software components running in the processor 904, resident/stored in the computer readable medium / memory 906, one or more hardware components coupled to the processor 904, or some combination thereof.

In one configuration, the apparatus 802/802′ may include means for detecting a real time light level of a scene. In one configuration, the means for detecting a real time light level of a scene may perform operations described above with reference to 702 in FIG. 7. In one configuration, the means for detecting a real time light level of a scene may be the light detection component 806 and/or the processor 904.

In one configuration, the apparatus 802/802′ may include means for determining a flash light setting for a plurality of flash lights based on the detected real time light level. In one configuration, the means for determining a flash light setting for a plurality of flash lights based on the detected real time light level may perform operations described above with reference to 704 in FIG. 7. In one configuration, the means for determining a flash light setting for a plurality of flash lights based on the detected real time light level may be the flash light setting determination component 808 and/or the processor 904.

In one configuration, the apparatus 802/802′ may include means for configuring the plurality of flash lights based on the flash light setting. In one configuration, the means for configuring the plurality of flash lights based on the flash light setting may perform operations described above with reference to 706 in FIG. 7. In one configuration, the means for configuring the plurality of flash lights based on the flash light setting may be the flash light configuration component 812 or the processor 904.

In one configuration, the apparatus 802/802′ may include means for capturing a video or snapshot of the scene with the configured plurality of flash lights. In one configuration, the means for capturing a video or snapshot of the scene with the configured plurality of flash lights may perform operations described above with reference to 708 in FIG. 7. In one configuration, the means for capturing a video or snapshot of the scene with the configured plurality of flash lights may be the camera 930, the memory 906, or the processor 904. In one configuration, the means for detecting the real time light level, the means for determining the flash light setting, and the means for configuring the plurality of flash light may operate periodically during a video capture session.

The aforementioned means may be one or more of the aforementioned components of the apparatus 802 and/or the processing system 914 of the apparatus 802′ configured to perform the functions recited by the aforementioned means.

It is understood that the specific order or hierarchy of blocks in the processes/flowcharts disclosed is an illustration of exemplary approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

What is claimed is:

1. A method of a user equipment (UE) including a plurality of flash lights, comprising:
detecting a real time light level of a scene;
determining a flash light setting for the plurality of flash lights based on the detected real time light level, the flash light setting comprising an operating voltage level for each of the plurality of flash lights and a number of the plurality of flash lights to be turned on; and
configuring the plurality of flash lights based on the flash light setting.

2. The method of claim 1, further comprising capturing a video or snapshot of the scene with the configured plurality of flash lights.

3. The method of claim 1, wherein a position of each of the plurality of flash lights determines whether the flash light will be turned on.

4. The method of claim 1, wherein the operating voltage level is less than a maximum supply voltage.

5. The method of claim 1, wherein the real time light level of the scene is detected with a light sensor.

6. The method of claim 1, wherein the real time light level of the scene is detected by analyzing the scene with a machine learning algorithm.

7. The method of claim 1, wherein the flash light setting is determined based on a set of rules.

8. The method of claim 1, wherein the flash light setting is determined based on a look-up table.

9. The method of claim 1, wherein the detecting the real time light level, the determining the flash light setting, and the configuring the plurality of flash light are performed periodically during a video capture session.

10. An apparatus, comprising:
means for detecting a real time light level of a scene;
means for determining a flash light setting for a plurality of flash lights based on the detected real time light level, the flash light setting comprising an operating voltage level for each of the plurality of flash lights and a number of the plurality of flash lights to be turned on; and
means for configuring the plurality of flash lights based on the flash light setting.

11. The apparatus of claim 10, further comprising means for capturing a video or snapshot of the scene with the configured plurality of flash lights.

12. The apparatus of claim 10, wherein a position of each of the plurality of flash lights determines whether the flash light will be turned on.

13. The apparatus of claim 10, wherein the operating voltage level is less than a maximum supply voltage.

14. The apparatus of claim 10, wherein the real time light level of the scene is detected with a light sensor.

15. The apparatus of claim 10, wherein the real time light level of the scene is detected by analyzing the scene with a machine learning algorithm.

16. The apparatus of claim 10, wherein the flash light setting is determined based on a set of rules.

17. The apparatus of claim 10, wherein the flash light setting is determined based on a look-up table.

18. The apparatus of claim 10, wherein the means for detecting the real time light level, the means for determining the flash light setting, and the means for configuring the plurality of flash light operate periodically during a video capture session.

19. An apparatus, comprising:
a memory; and
at least one processor coupled to the memory and configured to:
detect a real time light level of a scene;
determine a flash light setting for a plurality of flash lights based on the detected real time light level, the flash light setting comprising an operating voltage level for each of the plurality of flash lights and a number of the plurality of flash lights to be turned on; and
configure the plurality of flash lights based on the flash light setting.

20. The apparatus of claim 19, wherein the at least one processor is further configured to capture a video or snapshot of the scene with the configured plurality of flash lights.

21. The apparatus of claim 19, wherein a position of each of the plurality of flash lights determines whether the flash light will be turned on.

22. The apparatus of claim 19, wherein the operating voltage level is less than a maximum supply voltage.

23. The apparatus of claim 19, wherein the real time light level of the scene is detected with a light sensor.

24. The apparatus of claim 19, wherein the real time light level of the scene is detected by analyzing the scene with a machine learning algorithm.

25. The apparatus of claim 19, wherein the flash light setting is determined based on a set of rules.

26. The apparatus of claim 19, wherein the flash light setting is determined based on a look-up table.

27. The apparatus of claim 19, wherein the at least one processor is configured to periodically detect the real time light level, determine the flash light setting, and configure the plurality of flash light during a video capture session.

28. A computer-readable medium storing computer executable code, comprising code to:
detect a real time light level of a scene;
determine a flash light setting for a plurality of flash lights based on the detected real time light level, the flash light setting comprising an operating voltage level for each of the plurality of flash lights and a number of the plurality of flash lights to be turned on; and
configure the plurality of flash lights based on the flash light setting.
